(19) United States
(12) Patent Application Publication
(10) Pub. No.: US 2005/0001022 A1
(43) Pub. Date: Jan. 6, 2005

(54) Arnie device for resetting casino table drop boxes

(76) Inventor: Arnold K. Fieser, Bonita, CA (US)

Correspondence Address: Arnold K. Fieser, 353 Camino Elevado, Bonita, CA, 91902-2430, US

(21) Appl. No.: 10/609,733

(22) Filed: Jul. 1, 2003

(51) Int. Cl. G07B 15/00

(52) U.S. Cl. 232/15

(57) ABSTRACT

This device was invented to be used by casinos using table games. It will assist the count team in resetting drop boxes, which collect money or other items of value. It will assist in resetting the drop boxes quickly and with a small amount of effort. The use of this invention will replace the manual method of resetting drop boxes. It was specifically designed for use on the multi-shift drop boxes distributed by Spur Gaming of Zephyr Cove, Nev., however, can be adaptable to other drop box applications. The device is presently in use at a casino and they are extremely satisfied with its operation.

### CROSS REFERENCE TO RELATED APPLICATIONS

None

### STATEMENT OF FEDERALLY SPONSORED RESEARCH/DEVELOPMENT

None

### SEQUENCE LISTING

None

### BACKGROUND OF INVENTION

I am a contracting locksmith at a local Indian Casino, Sycuan Casino and Resort, 5485 Casino Way, El Cajon, Calif. 92019. They asked me if I had any ideas to make the resetting of the multi shift drop boxes, easier. These drop boxes are used in casino table games and are distributed by Spur Gaming, 295 Elks Point Rd., Zephyr Cove, Nev. 89448. On Apr. 26, 2003, I developed the first prototype, which did not work well. On May 3, 2003, I redesigned a new prototype, which worked extremely well. On May 6, 2003, I went public and showed the device to several supervisors at the Sycuan Casino. Among them were Director of Cash Operations, Director of Surveillance, and Director of Security. They immediately accepted the design and ordered four units. Three of the units were delivered to the casino on Jun. 10, 2003 and are now in operation. One unit was sent to Spur Gaming for their evaluation.

### BRIEF SUMMARY OF THE INVENTION

This device assists the casino count team in that after the count team has removed and counted the money or other contents from the box, they must reset the box to be put back into the gaming table at the next exchange of boxes. This would normally be done by reaching completely inside the box, using fingers to push up on the reset flange until the reset lock can be engaged. This device is inserted into the box and with very little effort to lower the handle, raises the reset flange for engaging the reset lock.

### BRIEF DESCRIPTION OF THE SEVERAL VIEWS OF THE DRAWING

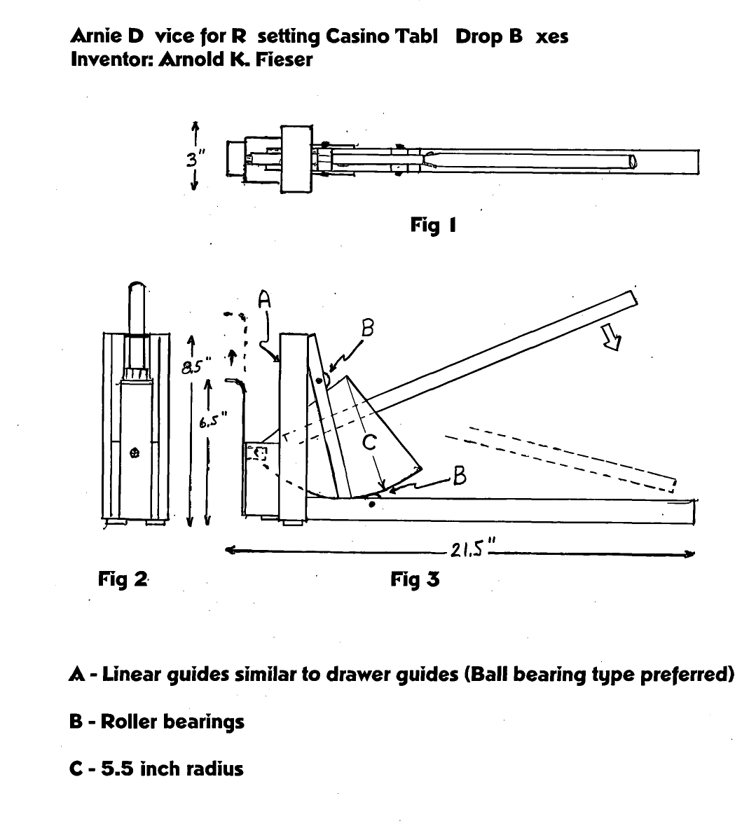

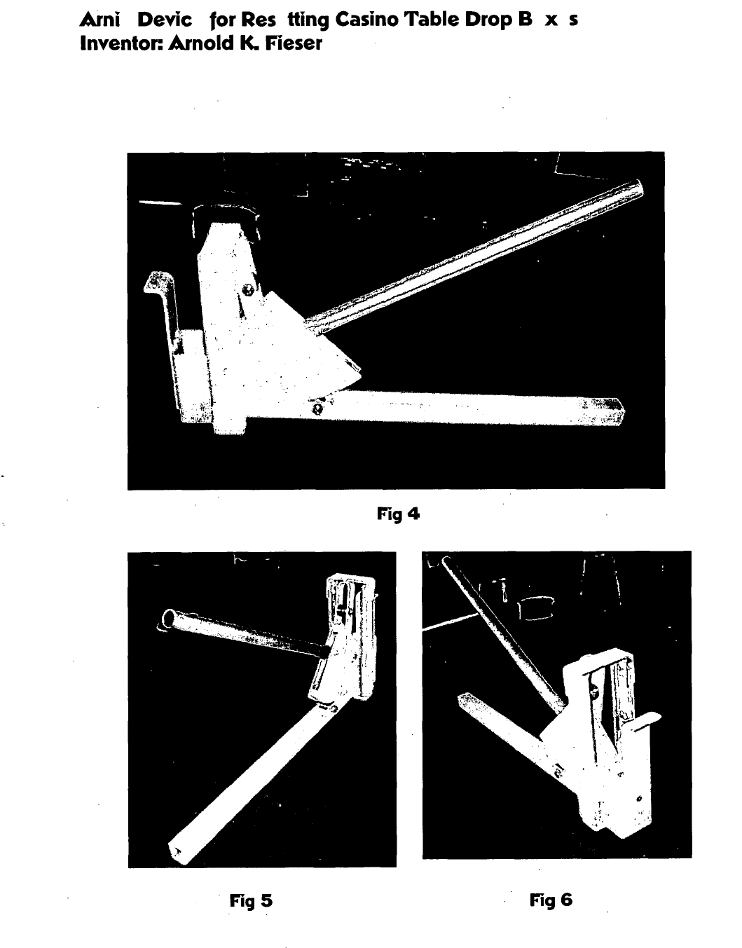

The device is shown in the normal three views (FIG. 1 to 3) on Drawing 1 of 2 and is also shown in the three photos (FIG. 4 to 6) on Drawing 2 of 2. The photos are included for clarity and may be used as part of the application if you so desire.

### DETAILED DESCRIPTION OF THE INVENTION

The device consists of a square tubular frame with two linear guides such as drawer guides attached at 90 degrees. The lifting tab is attached to the inside or movable part of the linear guide and raises approximately three inches. The quarter circle sections are attached to the lifting tab at one corner. The quarter circle sections then ride on roller bearings. When the quarter circle section is rotated, the lifting tab, which engages the reset flange on the drop box, rises vertical and linearly so that the reset lock may be engaged. The handle is attached to the quarter circle section to rotate it. The heart of the device is the mechanism, which changes rotational motion to linear motion. The material used to construct the device can be steel, aluminum or a combination of both as the ones I produced are. A copy of the instructions, which are handed out for use of the device, is on the next page.

A. Turn all three release locks to the unlocked position. For the medico locks, the three keys will be in one line.

B. Insert device, holding the square frame with the round handle in the up position; push in until it stops on the back wall. Check to see that the device is somewhat to the right side of the back wall.

C. Push down on the handle to the bottom position, turn the left release lock to the locked or set position. Lift up on handle and remove device. Turn the other two locks to the locked or set position.

D. If while pushing down on the handle, a solid resistance is felt, DO NOT FORCE. STOP. Or if the device does not catch the reset flange on the box: do the following items:
a. Check that all three locks are in the fully unlocked position.
b. Make sure device is all the way against the back wall and to the right side.
c. If resistance is still felt, pull device out, push down hard on the lifting tab on the front of the device, and start on #1 again.
d. If box will still not reset, have box checked for a possible jam.
   Do not Force Handle Down

E. Occasionally, the ball bearing race will not let the lifting tab on the front of the device to go to the fully down position. This will make the device miss the reset flange on the box and not reset the drop box. Simply push down hard on the lifting tab and the problem is solved. On some devices you may have to push down on the lifting tab every second or third reset.

1. A device that will assist in the resetting of Casino table gaming drop boxes by lifting up on the box's reset flange so that the reset lock may be engaged.

2. A device that will reset the drop box with substantially less effort than resetting the drop boxes without such a device.

3. A device that will reset the drop box without placing hand and arm inside the box.

4. A device that is adaptable to other drop box applications by changing some dimensions on the device.
